(19) United States
(12) Patent Application Publication
(10) Pub. No.: US 2006/0259774 A1
(43) Pub. Date: Nov. 16, 2006

(54) WATERMARK COUNTER WITH RELOAD REGISTER

(75) Inventors: Gary L. Swoboda, Sugar Land, TX (US); Jason L. Peck, Sugar Land, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/383,464

(22) Filed: May 15, 2006

Related U.S. Application Data
(60) Provisional application No. 60/680,668, filed on May 13, 2005.
(60) Provisional application No. 60/681,427, filed on May 16, 2005.

(51) Int. Cl. H04L 9/00

(52) U.S. Cl. 713/176

(57) ABSTRACT

A series of instructions from executable code are implemented on a processor core which in turn outputs event data. A watermark counter inputs event data and counts the number of events that occur within a time period defined by a start and stop signal. The watermark counter outputs a count value, corresponding to the number of events counted in the time period, across a connection to a monitoring computer.

### CROSS-REFERENCE TO RELATED APPLICATIONS

This application claims the benefit of U.S. Provisional Application Ser. No. 60/680,668 filed May 13, 2005, titled “Advanced Event Triggering Watermark Counter CTool,” and U.S. Provisional Application Ser. No. 60/681,427 filed May 16, 2005, titled “Debugging Software-Controlled Cache Coherence,” both of which are incorporated by reference herein as if reproduced fully below.

This application also may contain subject matter that may relate to the following commonly assigned co-pending applications incorporated herein by reference: “Real-Time Monitoring, Alignment, and Translation of CPU Stalls or Events,” Ser. No. ______, filed May 12, 2006, Attorney Docket No. TI-60586 (1962-31400); “Event and Stall Selection,” Ser. No.______, filed May 12, 2006, Attorney Docket No. TI-60589 (1962-31500); “Real-Time Prioritization of Stall or Event Information,” Ser. No.______, filed May 12, 2006, Attorney Docket No. TI-60647 (1962-33000); “Method of Translating System Events Into Signals For Activity Monitoring,” filed May 12, 2006, Attorney Docket No. TI-60649 (1962-33100); “System and Methods For Stall Monitoring,” Ser. No.______, filed May 12, 2006, Attorney Docket No. TI-60639 (1962-34200); “Monitoring of Memory and External Events,” Serial No.______, filed May 12, 2006, Attorney Docket No. TI-60642 (1962-34300); “Event-Generating Instructions,” Ser. No.______, filed May 12, 2006, Attorney Docket No. TI-60659 (1962-34500); and “Selectively Embedding Event-Generating Instructions,” Ser. No.______, filed May 12, 2006, Attorney Docket No. TI-60660 (1962-34600).

### BACKGROUND

Integrated circuits are ubiquitous in society and can be found in a wide array of electronic products. Regardless of the type of electronic product, most consumers have come to expect greater functionality when each successive generation of electronic products are made available because successive generations of integrated circuits offer greater functionality such as faster memory or microprocessor speed. Moreover, successive generations of integrated circuits that are capable of offering greater functionality are often available relatively quickly. For example, Moore's law, which is based on empirical observations, predicts that the speed of these integrated circuits doubles every eighteen months. As a result, integrated circuits with faster microprocessors and memory are often available for use in the latest electronic products every eighteen months.

Although successive generations of integrated circuits with greater functionality and features may be available every eighteen months, this does not mean that they can then be quickly incorporated into the latest electronic products. In fact, one major hurdle in bringing electronic products to market is ensuring that the integrated circuits, with their increased features and functionality, perform as desired. Generally speaking, ensuring that the integrated circuits will perform their intended functions when incorporated into an electronic product is called “debugging” the electronic product. Also, determining the performance, resource utilization, and execution of the integrated circuit is called “profiling” the electronic product. Profiling is used to modify code execution on the integrated circuit so as to change the behavior of the integrated circuit as desired. The amount of time that debugging and profiling takes varies based on the complexity of the electronic product. One risk associated with the process of debugging and profiling is that it delays the product from being introduced into the market.

To prevent delaying the electronic product because of delay from debugging and profiling the integrated circuits, software based simulators that model the behavior of the integrated circuit are often developed so that debugging and profiling can begin before the integrated circuit is actually available. While these simulators may have been adequate in debugging and profiling previous generations of integrated circuits, such simulators are increasingly unable to accurately model the intricacies of newer generations of integrated circuits. Specifically, these simulators are not always able to accurately model events that occur in integrated circuits that incorporate cache memory. Further, attempting to develop a more complex simulator that copes with the intricacies of integrated circuits with cache memory takes time and is usually not an option because of the preferred short time-to-market of electronic products. Unfortunately, a simulator's inability to effectively model cache memory events results in the integrated circuits being employed in the electronic products without being debugged and profiled fully to make the integrated circuit behave as desired.

### SUMMARY

Disclosed herein is a system and method for debugging and/or profiling executable code for implementation on a processor core. A series of instructions from executable code are implemented on a processor core which in turn outputs event data. A watermark counter inputs event data from the processor core and other components and counts the number of events that occur within a time period defined by a start and stop signal. The watermark counter records a count value, corresponding to the number of events counted in the time period, to a storage component that is accessible by both embedded code and by a monitoring computer across a connection.

In a preferred embodiment, the watermark counter outputs a minimum or maximum count value out of one or a series of count values that were counted during one or more time periods.

### BRIEF DESCRIPTION OF THE DRAWINGS

FIG. 1 depicts an exemplary debugging and profiling system.

FIG. 2 depicts an exemplary embodiment of the circuitry being debugged and profiled.

FIG. 3 depicts an exemplary embodiment of the watermark counter in the circuitry.

FIG. 4 depicts the operation of the watermark counter of FIG. 3 in a MAX operation mode with both watermark windows updating the watermark register.

FIG. 5 depicts the operation of the watermark counter of FIG. 3 in a MAX operation mode with only the first watermark windows updating the watermark register.

FIG. 6 depicts the operation of the watermark counter of FIG. 3 in a MIN operation mode with only the first watermark windows updating the watermark register.

FIG. 7 depicts the operation of the watermark counter of FIG. 3 in a MIN operation mode with both watermark windows updating the watermark register.

### DETAILED DESCRIPTION

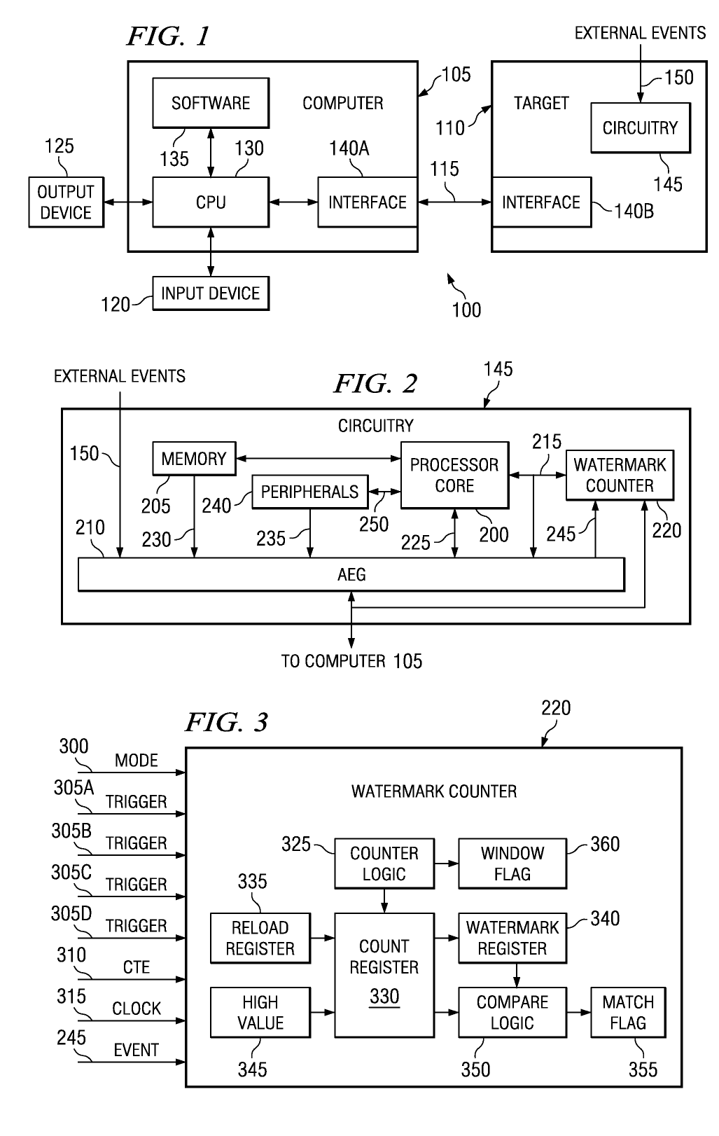

FIG. 1 depicts an exemplary debugging and profiling system 100 including a host computer 105 coupled to a target device 110 through a connection 115. A user may debug and profile the operation of the target device 110 by operating the host computer 105. The target device 110 may be debugged and profiled in order for the operation of the target device 110 to perform as desired (for example, in an optimal manner) with circuitry 145. To this end, the host computer 105 may include an input device 120, such as a keyboard or mouse, as well as an output device 125, such as a monitor or printer. Both the input device 120 and the output device 125 couple to a central processing unit 130 (CPU) that is capable of receiving commands from a user and executing software 135 accordingly. Software 135 interacts with the target 110 and may allow the debugging and profiling of applications that are being executed on the target 110. Note that while the above description indicates that software 135 executed on computer 105 allows for code to be executed on target device 110 by circuitry 145, code may also be embedded within target device 110 or circuitry 145 itself. This embedded code would also allow a user to debug and profile the operation of circuitry 145 by instrumenting the code embedded on the target device 110 or circuitry 145.

Connection 115 may be a wireless, hard-wired, or optical connection. In the case of a hard-wired connection, connection 115 is preferably implemented in accordance with any suitable protocol such as a Joint Testing Action Group (JTAG) type of connection. Additionally, hard-wired connections may include real time data exchange (RTDX) types of connection developed by Texas instruments, Inc. Briefly put, RTDX gives system developers continuous real-time visibility into the applications that are being developed on the target 110 instead of having to force the application to stop, via a breakpoint, in order to see the details of the application execution. Both the host 105 and the target 110 may include interfacing circuitry 140A and 140B to facilitate implementation of JTAG, RTDX, or other interfacing standards.

The target 110 preferably includes the circuitry 145 executing firmware code being actively debugged and profiled. Throughout the execution of the code by circuitry 145 events external to circuitry 145 may occur which impact the operation and execution of code by circuitry 145. These external events 150 may occur on the target device 110 or external to target device 110. In some embodiments, the target 110 may be a test fixture that accommodates the circuitry 145 when code being executed by the circuitry 145 is being debugged and profiled. The debugging and profiling may be completed prior to widespread deployment of the circuitry 145. For example, if the circuitry 145 is eventually used in cell phones, then the executable code may be designed using the target 110.

The circuitry 145 may include a single integrated circuit or multiple integrated circuits that will be implemented as part of an electronic device. For example, the circuitry 145 may include multi-chip modules comprising multiple separate integrated circuits that are encapsulated within the same packaging. Regardless of whether the circuitry 145 is implemented as a single-chip or multiple-chip module, the circuitry 145 may eventually be incorporated into electronic devices such as cellular telephones, portable gaming consoles, network routing equipment, or other computers.

Debugging and profiling the executable firmware code on the target 110 using breakpoints to see the details of the code execution is an intrusive process and affects the operation and performance of the code and circuitry 145. As such, a true understanding of the operation and performance of the code execution on circuitry 145 is not gained through the use of breakpoints.

On the other hand, debugging and profiling the executable firmware code using a trace to monitor all of the interactions enable a user of the computer 105 to see in real-time the operation of the circuitry interactions and code being implemented on circuitry 145. As circuitry 145 increase in speed the number of operations being implemented similarly increase, however, the bandwidth between computer 105 and target 110 through connection 115 is limited and the amount of data generated by using a trace is now exceeding the limited bandwidth.

As such, intelligent ways of compressing the data without loosing any or much information are being implemented. FIG. 2 depicts an exemplary embodiment of circuitry 145 including a processor core 200 and memory 205. Processor core 200 interacts with memory 205 to input instructions and data and output data manipulated according to the instructions. Memory 205 may comprise a cache memory with multiple levels of cache. While not depicted, memory 205 may also communicate with an external memory to exchange any data or instructions not present in memory 205. Through the operation of the processor core 200, memory system 205, peripherals 240, or factors external to the circuitry 145, many events 225, 230, 235, 150 may occur that are significant for debugging and profiling the executable firmware code being run by the processor core 200 or the behavior of the entire system 145. The term “events” or “event data” herein is being used broadly to describe any type of stall, such as a CPU stall or cache stall, any type of memory event, and any other miscellaneous signals which are useful for debugging and profiling the executable firmware code and system behavior of the circuitry 145. For example a system bus may also be monitored in order to collect event data.

One way for compressing this event data, in accordance with a preferred embodiment of the invention, is through the use of an advanced event generator (AEG) 210 embedded on the circuitry 145 under the control of processor core 200 through control signals 215. The AEG 210 inputs event data 225, 230, 235, 150 and selectively outputs or combines the event data to be sent to computer 105 so as to alleviate the constraints caused by the limited bandwidth of connection 115. For example, if there is a read miss on a first level cache in memory 205 and a read hit on a second level cache in memory 205 then instead of using up limited bandwidth to communicate both of these events to computer 105, the AEG 210 would selectively output only that there was a read hit on a second level cache in memory 205. The information indicating that there was a read hit on a second level cache in memory 205 already denotes that there must have already been a read miss on the first level cache in memory 205. As such, instead of having to communicate two pieces of event data to computer 105, only one piece of event data is communicated and therefore less bandwidth is used. Related application Attorney Docket Number 1962-31400 “Real-Time Monitoring, Alignment, and Translation of CPU Stalls or Events”, by Sohm et al. details an implementation of an advanced event generator. The content of the above referenced application is herein incorporated by reference in its entirety.

Another way of compressing the event data, in accordance with a preferred embodiment of the invention, is through the use of a watermark counter 220. Processor core 200 utilizes control signals 215 to input control data and select various modes of operation for watermark counter 220. A computer 105 may also directly access said control signals 215 to input control data and select various modes of operation for watermark counter 220 through connection 115. Watermark counter 220 may input data 245 generated by AEG 210 to further compress the event data. This may be accomplished through the watermark counter 220 counting the number of times an event occurs in a particular debugging or profiling session and the resultant count value may be retrieved by the computer 105 through connection 115. In the example used above with regard to the AEG 210, event data indicating a read hit on a second level cache is output from the AEG. This event data may be input to the watermark counter 220 to count the number of times a read hit on a second level cache occurs in a particular debugging or profiling session. As such, instead of having a trace output data to computer 105 every time a read hit on a second level cache occurs, the value of watermark counter 220 indicating the number of times that event occurred in a particular debugging or profiling session is instead simply retrieved once by the computer 105 over connection 115. It is noted that while a single watermark counter 220 is illustrated, there may be multiple counters used to count multiple events output from the AEG 210. Further, while the circuitry 145 in the above description used an AEG 210 to first combine or selectively output event data, the event data 225, 230, 235, 150, or other event data such as that collected from a system bus, may be directly input into one or more watermark counters 220 without implementing the AEG 210 on circuitry 145. Note that the event data may be input to watermark counter 220 either synchronized or asynchronous to the timing of watermark counter 220. The operation of watermark counter 220 is discussed in detail below with regard to FIG. 3.

FIG. 3 depicts an exemplary watermark counter 220. Watermark counter 220 receives various inputs from processor core 200 including mode signals 300 for selecting a mode of operation for watermark counter 220, trigger signals 305A, 305B, 305C and 305D to control operation of the watermark counter 220, counter enable (CTE) signals 310 to enable and disable the watermark counter 220, and clock signals 315 for providing timing to the watermark counter. Watermark counter 220 may also receive an output of the AEG 210 as an input event 245. Note that the data asserted on the input event 245 may be provided either synchronously or asynchronously to the clock signals on clock input 315. Also note that while the above description indicates that trigger signal 305C and 305D are supplied from the processor core 200, other signals such as event data may be used to supply the inputs for trigger signals 305C and 305D.

Mode signals 300 may place watermark counter 220 in one of three operation modes: a generic mode, a MIN mode, and a MAX mode. Within each of these operation modes the mode signals 300 may additionally operate the watermark counter 220 in one of four counting modes: a counter mode, an event mode, a continuous timer mode, and a one shot timer mode.

In the counter mode, counter logic 325 is configured to instruct count register 330 to be used as a simple counter to count loop counts, auxiliary events and the like. “Dead man” timer functions are also supported in the counter mode. When trigger signal 305A is activated counter logic 325 instructs count register 330 to count and when trigger signal 305B is activated counter logic 325 instructs count register 330 to reload. When the reload instruction is received by count register 330 all of the state information is initialized and the value of reload register 335 is loaded into the count register 330. If both trigger signals 305A and 350B are activated simultaneously then the reload signal takes precedence. When the watermark counter 220 is disabled using the CTE signal 310 the state information within the watermark counter 220 is initialized and the value of reload register 335 is loaded into the count register 330.

In the event mode, counter logic 325 is configured to instruct count register 330 to be used as a counter which decrements every time an input event 245 occurs. Preferably, the output from the AEG 210 is used as the input event 245 in the event mode, however, watermark counter 220 may also use any other event data 225, 230, 235, 150 as the input event 245. When the watermark counter 220 is disabled using the CTE signal 310 the state information within the watermark counter 220 is initialized and the value of a reload register 335 is loaded into the count register 330. Trigger signals 305A and 305B have no effect in the event mode.

In the continuous timer mode, counter logic 325 is configured to instruct count register 330 to be used as a timer. Trigger signal 305A starts the counter in the same clock cycle that it is received and the trigger signal 305B stops the counter the next clock cycle from when it is received. Once started, the counter continues to count until trigger signal 305B is received. Should the watermark counter 220 receive trigger signals 305A and 305B at the same time, the count register 330 would only count for the clock cycle where the trigger signals 305A and 305B were received and would not continue counting unless trigger signal 305A was received in the next clock cycle. When the watermark counter 220 is disabled using the CTE signal 310 the state information within the watermark counter 220 is initialized and the value of reload register 335 is loaded into the count register 330.

In the one shot timer mode, counter logic 325 is configured to instruct count register 330 to be used as a one shot timer. The first timer trigger signal 305A is received after the watermark counter 220 is enabled causes count register 330 to start decrementing. The first time trigger signal 305B is received after trigger signal 305A is received causes count register 330 to halt, and it will remain halted until it is disabled using CTE signal 310. This means that the count register 330 will count after trigger signal 305A is received, and continue to count until the clock cycle after trigger signal 305B is received. If trigger signals 305A and 305B are received in the same clock cycle, then a count action for one cycle will occur. If trigger signals 305A and 305B are received on two consecutive clock cycles, then a count action for only a single clock occurs. If trigger signal 305B is received prior to trigger signal 305A, then it is ignored. When the watermark counter 220 is disabled using the CTE signal 310 the state information within the watermark counter 220 is initialized and the value of reload register 335 is loaded into the count register 330.

Note that while the watermark counter 220 was described above as operating in one of four counting modes the watermark counter 220 may also operate in any other known counting mode. Further, in all of the above counter modes, if a reload register is not implemented then when initializing the watermark counter 220, preferably a zero value may be loaded.

In the generic operation mode, watermark counter 220 simply operates in one of the above four counting modes and watermark counter 220 uses the value in count register 330 as the output value to be retrieved by computer 105 or by embedded code running in circuitry 145.

For example, if it is desired to determine the number of second level cache hits occurring in a debugging or profiling session, then the watermark counter 220 is set to operate in the generic mode with the counting mode set to the event mode. The AEG 210 may be instructed to output a signal to the input event 245 of watermark counter 220 every time a second level cache hit occurs. The watermark counter 220 would then count the number of times a read hit on a second level cache occurs until watermark counter 220 was disabled, which initializes the state of watermark counter 220. The resultant number of read hits on a second level cache may be read out from count register 330 by computer 105 or by embedded code running in circuitry 145.

In the MIN operation mode counter logic 325 is configured to instruct count register 330 to act in one of the four counter modes and watermark counter 220 determines the smallest count value incurred within a watermark window over the course of one or more watermark windows in a debugging or profiling session. A watermark window is defined as the window of time occurring between a start signal activated by trigger signal 305C and an end signal activated by trigger signal 305D. At the end of each watermark window a determination is made as to whether or not the count value held in count register 330 is less than the value held in watermark register 340. If so, then the value of the count register 330 is transferred to the watermark register 340, thus indicating a new minimum value. If not, then the value in watermark register 340 remains unchanged. The resultant minimum may be read out from watermark register 340 by computer 105 or by embedded code running in circuitry 145.

For example, if it is desirable to determine the least amount of time it takes to execute a series of instructions on processor core 200 in a debugging or profiling session, then watermark counter 220 may be placed in a MIN operating mode and a continuous timer counting mode. Each time the processor core 200 starts to execute the series of instructions a signal is sent to trigger signal 305C to set the start of a watermark window and using trigger signal 305A to start count register 330 counting. Upon the processor core 200 completing the series of instructions a signal is sent to trigger signal 305D to set the end of a watermark window and using trigger signal 305B to stop count register 330 from counting. The count value held in count register corresponds to the amount of time it took processor core 200 to execute the series of instructions. A determination is made if the value held in count register 330 is less than the value held in watermark register 340. If so, then the value of the count register 330 is transferred to the watermark register 340, thus indicating a new minimum value. If not, then the value in watermark register 340 remains unchanged. Processor core 200 may execute the series of instructions one or more times in a debugging or profiling session. At the end of the session the value in the watermark counter 340 corresponds to the least amount of time it took processor core 200 to execute the series of instructions. The value of watermark counter 340 may be read out by computer 105 or by embedded code running in circuitry 145.

Similarly, in the MAX operation mode, counter logic 325 is configured to instruct count register 330 to act in one of the four counter modes and watermark counter 220 determines the largest count value incurred within a watermark window over the course of one or more watermark windows in a debugging or profiling session.

A detailed description of the operation of one embodiment of watermark counter 220 in the MIN operation mode is made with regard to FIG. 3. In the MIN operation mode watermark register 340 is initialized to a very low value and count register 330 is initialized to the hardwired high value 345. Trigger signal 305C marks the start of a watermark window and the count register 330 operates to decrement according to the count mode set by mode signals 300 and the trigger signals 305A and 305B. Compare logic 350 is used to compare the values in count register 330 and watermark register 340 every clock cycle and if the values of both registers match then match flag 355 is set. Once trigger signal 305D is received counter logic 325 will set a window flag 360 to indicate that at least one complete watermark window has occurred. Upon receiving trigger signal 305D if the match flag 355 is not set then the value in the count register 330 has not counted enough times to count down to the value in the watermark register 340, and as such a new minimum is found. Therefore, the value of the watermark register 340 is updated with the value in the count register 330.

A detailed description of the operation of watermark counter 220 in the MAX operation mode is made with regard to FIG. 3. In the MAX operation mode both watermark register 340 and count register 330 are initialized to the hardwired high value 345. Trigger signal 305C marks the start of a watermark window and the count register 330 operates to decrement according to the count mode set by mode signals 300 and the trigger signals 305A and 305B. Compare logic 350 is used to compare the values in count register 330 and watermark register 340 every clock cycle and if the values of both registers match then match flag 355 is set. Once trigger signal 305D is received counter logic 325 will set a window flag 360 to indicate that at least one complete watermark window has occurred. Upon receiving trigger signal 305D, if the match flag 355 is set then the value in the count register 330 has counted enough times to count down to the value in the watermark register 340, and as such a new maximum is found. Therefore, the value of the watermark register 340 is updated with the value in the count register 330.

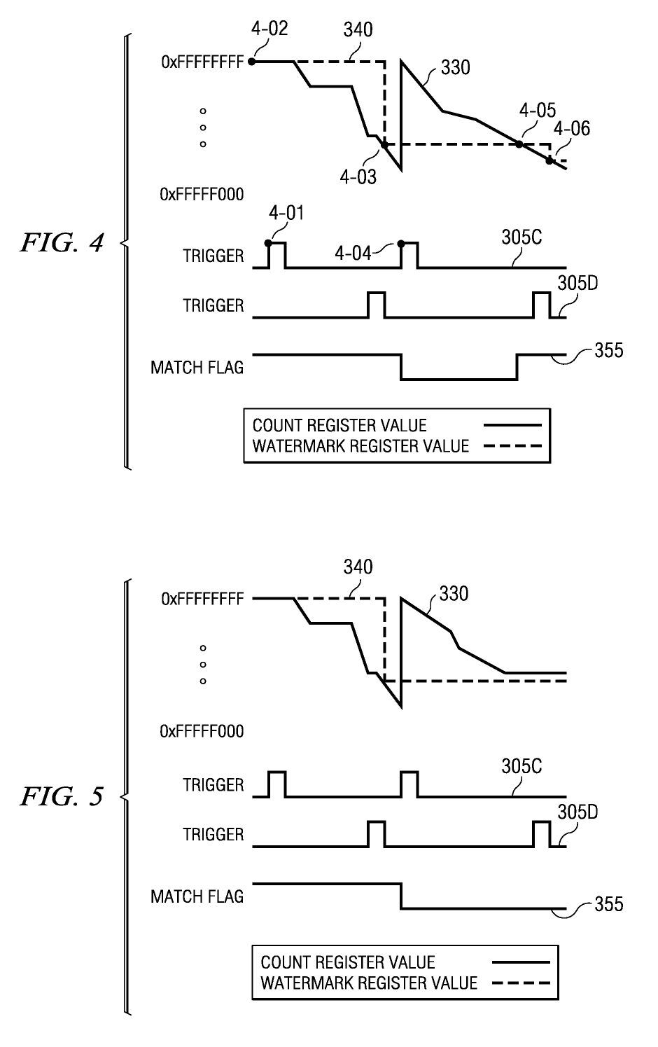

Several examples of the operation of watermark counter 220 will be explained below with reference to FIGS. 4-7.

An example of the watermark counter 220 operating in the MAX operation mode is shown in FIG. 4. The count register 330 and watermark register 340 have been initialized to a value of 0xFFFFFFFF. A first window is started by the rising edge of trigger signal 305C at point 4-01. During the first window a match is immediately declared and match flag 355 is set since the value in the count register 330 has been determined by the compare logic 350 to equal the value in the watermark register 340 at point 4-02. The count register 330 continues to count as dictated by the count mode and the trigger signals 305A and 305B until one cycle after receiving trigger signal 305D at point 4-03. Since the watermark counter 220 is operating in the MAX operation mode and the match flag 355 has been set then the value of watermark register 340 is updated with the value in count register 330. Further, since at least one complete watermark window has occurred window flag 360 is set.

A second window is started by the rising edge of trigger signal 305C at point 4-04. At this point the match flag 355 and count register 330 are reset. Since the count register 330 is counting in the same cycle as the trigger signal 305C instead of resetting count register 330 to the value 0xFFFFFFFF it is set to the value 0xFFFFFFFE. The count register 330 continues to count as dictated by the count mode and the trigger signals 305A and 305B until the compare logic 350 determines that the value in the count register 330 equals the value in the watermark register 340 and sets the match flag 355 at point 4-05. The count register 330 again continues to count until one cycle after receiving trigger signal 305D at point 4-06. Since the watermark counter 220 is operating in the MAX operation mode and the match flag 355 has been set then the value of watermark register 340 is updated with the value in count register 330.

If the debugging or profiling session ends after the end of the second window then the value of the watermark register 340 is read by computer 105 or by embedded code running in circuitry 145.

Another example the watermark counter 220 operating in the MAX operation mode is shown in FIG. 5. The count register 330 and watermark register 340 have been initialized to a value of 0xFFFFFFFF. Similar to the case described in the first window of example 1, a first window is started by the rising edge of trigger signal 305C. During the first window a match is immediately declared and match flag 355 is set since the value in the count register 330 has been determined by the compare logic 350 to equal the value in the watermark register 340. The count register 330 continues to count as dictated by the count mode and the trigger signals 305A and 305B until one cycle after receiving trigger signal 305D. Since the watermark counter 220 is operating in the MAX operation mode and the match flag 355 has been set then the value of watermark register 340 is updated with the value in count register 330. Further, since at least one complete watermark window has occurred window flag 360 is set.

A second window is started by the rising edge of trigger signal 305C. At this point the match flag 355 and count register 330 are reset. Since the count register 330 is not counting in the same cycle as the trigger signal 305C the count register 330 is reset to the value 0xFFFFFFFF. The count register 330 continues to count as dictated by the count mode and the trigger signals 305A and 305B until one cycle after receiving trigger signal 305D. Since the watermark counter 220 is operating in the MAX operation mode and the match flag 355 has not been set, the value of watermark register 340 stays the same.

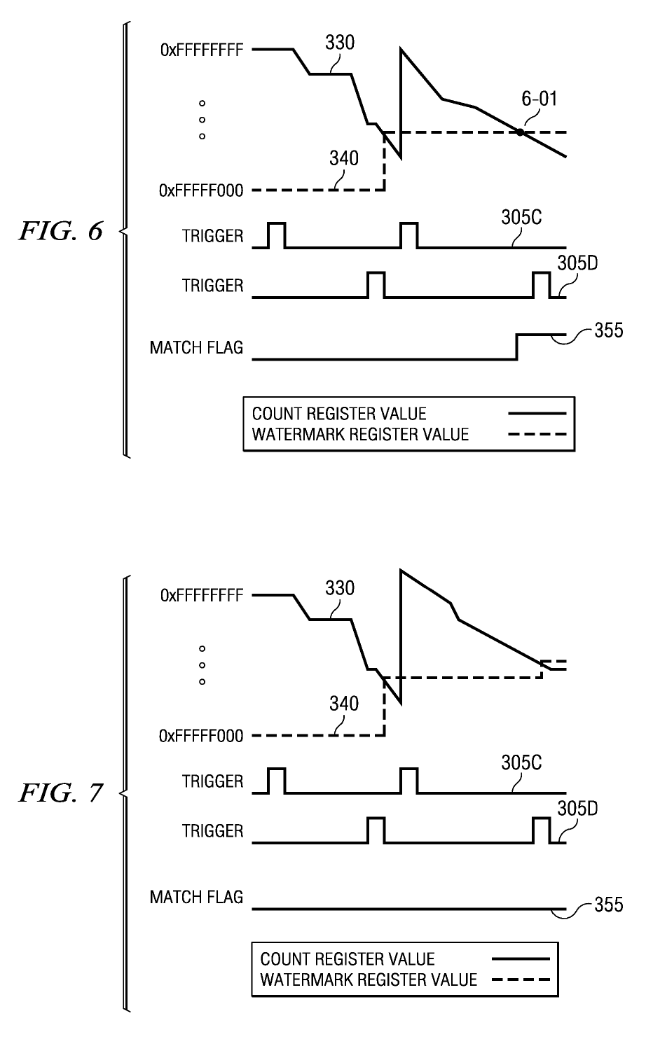

An example of the watermark counter 220 operating in the MIN operation mode is shown in FIG. 6. The count register 330 has been initialized to a value of 0xFFFFFFFF and the watermark register 340 has been initialized to a value of 0xFFFFF000. A first window is started by the rising edge of trigger signal 305C. During the first window the count register 330 counts as dictated by the count mode and the trigger signals 305A and 305B until one cycle after receiving trigger signal 305D. Since the watermark counter 220 is operating in the MIN operation mode and the match flag 355 has not been set then the value of watermark register 340 is updated with the value in count register 330. Further, since at least one complete watermark window has occurred window flag 360 is set.

A second window is started by the rising edge of trigger signal 305C. At this point the match flag 355 and count register 330 are reset. Since the count register 330 is counting in the same cycle as the trigger signal 305C instead of resetting count register 330 to the value 0xFFFFFFFF it is set to the value 0xFFFFFFFE. The count register 330 continues to count as dictated by the count mode and the trigger signals 305A and 305B until the compare logic 350 determines that the value in the count register 330 equals the value in the watermark register 340 and sets the match flag 355 at point 6-01. The count register 330 again continues to count until one cycle after receiving trigger signal 305D. Since the watermark counter 220 is operating in the MIN operation mode and the match flag 355 has been set then the value of watermark register 340 stays the same.

Another example the operation of watermark counter 220 when it has been set in the MIN operation mode is shown in FIG. 7. The count register 330 has been initialized to a value of 0xFFFFFFFF and the watermark register 340 has been initialized to a value of 0xFFFFF000. A first window is started by the rising edge of trigger signal 305C. During the first window the count register 330 counts as dictated by the count mode and the trigger signals 305A and 305B until one cycle after receiving trigger signal 305D. Since the watermark counter 220 is operating in the MIN operation mode and the match flag 355 has not been set then the value of watermark register 340 is updated with the value in count register 330. Further, since at least one complete watermark window has occurred window flag 360 is set.

A second window is started by the rising edge of trigger signal 305C. At this point the match flag 355 and count register 330 are reset. Since the count register 330 is not counting in the same cycle as the trigger signal 305C count register 330 is reset to the value 0xFFFFFFFF. The count register 330 counts as dictated by the count mode and the trigger signals 305A and 305B until one cycle after receiving trigger signal 305D. Since the watermark counter 220 is operating in the MIN operation mode and the match flag 355 has not been set then the value of watermark register 340 is again updated with the value in count register 330.

It is noted that any activity by count register 330 outside of a watermark window is ignored. Further, it is noted that multiple watermark windows may occur back-to-back without any delay between one cycle after receiving trigger signal 305D and receiving trigger signal 305C.

As such, described above is a watermark counter 220 for compressing event data output from a processor core 200 without loosing any or much information so as communicate event data to a monitoring computer 105 across a limited bandwidth connection. Computer 105 executes debugging or profiling software 135 to interpret event data and enable the executable firmware code to be implemented using circuitry 145 as desired.

While various system and method embodiments have been shown and described herein, it should be understood that the disclosed systems and methods may be embodied in many other specific forms without departing from the spirit or scope of the invention. The present examples are to be considered as illustrative and not restrictive. The intention is not to be limited to the details given herein, but may be modified within the scope of the appended claims along with their full scope of equivalents.

What is claimed is:

1. A system comprising:
a system that may be instrumented to define events;
a signal that defines a time period based on events or through other signals;
a counter configured to count the number of events occurring in one such time period;
said counter recording the event count that was generated during a single time period and outputs the maximum or minimum event count that was recorded for any one time period where recording occurred to a storage component.

2. The system of claim 1, further comprising:
an event source which is a central processing unit (CPU) in the system.

3. The system of claim 1, further comprising:
an event source which is a memory system or memory system component.

4. The system of claim 1, further comprising:
an event source which is a peripheral in the system.

5. The system of claim 1, further comprising:
an event source which is system busses within the system.

6. The system of claim 1, further comprising:
an event source which is activity external to the system component containing the counter.

7. The system of claim 1, further comprising:
an event source which is activity synchronous to the clock domain in which the counter operates.

8. The system of claim 1, further comprising:
an event source which is activity asynchronous to the clock domain in which the counter operates.

9. A system of claim 1, wherein:
an event source is selectable from one or more of the following events which are synchronous or asynchronous to the clock domain in which the counter operates: central processing unit, memory system or memory system component, peripheral in the system, system busses within the system, or activity external to the system component containing the counter.

10. The system of claim 1, wherein:
said storage component is accessible by embedded code being executed within the system or across a connection to a monitoring computer.

11. The system of claim 1, wherein:
said watermark counter is configured to output whether or not at least one complete time period has occurred.

12. The system of claim 1, wherein:
said watermark counter is configured to count events in one or more modes selected from the list comprising a counter mode, an event mode, a continuous timer mode, a one shot timer mode, or any combination thereof.

13. The system of claim 10, wherein:
said connection has less bandwidth than would be necessary to output all of said event data to said monitoring computer.

14. The system of claim 10, wherein:
said embedded code or monitoring computer interprets event data that was read from said watermark counter to debug and/or profile the implementation of said executable code by said processor core.

15. A method of reducing an amount of event data, comprising:
implementing a series of instructions from executable code on a processor core;
outputting event data from said processor core or other components;
counting a number of events occurring within a time period based on events or other signals; and
outputting a minimum or maximum count value, corresponding to the number of events counted in said time period, to a storage component.

16. The method of claim 15, wherein:
said storage component is accessible by embedded code being executed within the system or across a connection to a monitoring computer.

17. The method of claim 15, further comprising:
outputting to a storage component a signal corresponding to whether or not at least one complete time period, defined by said events or other signals, has occurred.

18. The method of claim 15, wherein:
said counting step counts events in one or more modes selected from the list comprising a counter mode, an event mode, a continuous timer mode, a one shot timer mode, or any combination thereof.

19. The method of claim 16, wherein:
said connection has less bandwidth than would be necessary to output all of said event data output from said processor core.

20. The method of claim 15, further comprising:
interpreting event data that was output to said storage component to debug and/or profile the implementation of said executable code by said processor core.

21. A computer readable medium containing computer instructions, which when executed by the computer, cause the computer to:
implement a series of instructions from executable code on a processor core;
read a count value from a storage component corresponding to a maximum or minimum number of events occurring within any one time period defined by events or through other means.

22. The computer readable medium of claim 21, wherein:
said read instruction reads said count value across a connection.

23. The computer readable medium of claim 21 further containing computer instructions, which when executed by the computer, cause the computer to:
receive across a connection a signal corresponding to whether or not at least one complete time period has occurred.

24. The computer readable medium of claim 21 further containing computer instructions, which when executed by the computer, cause the computer to:
instruct a counter to count in one or more modes selected from the list comprising a counter mode, an event mode, a continuous timer mode, a one shot timer mode, or any combination thereof.

25. The computer readable medium of claim 21 further containing computer instructions, which when executed by the computer, cause the computer to:
interpret said read count value to debug and/or profile the implementation of said executable code by said processor core.
